(19) United States
(12) Patent Application Publication
(10) Pub. No.: US 2026/0095348 A1
(43) Pub. Date: Apr. 2, 2026

(54) WIRELESS COMMUNICATION APPARATUS AND OPERATING METHOD THEREOF

(71) Applicant: Samsung Electronics Co., Ltd., Suwon-si (KR)

(72) Inventors: Minki AHN, Suwon-si (KR); Myeongjin KIM, Suwon-si (KR); Sungsoo KIM, Suwon-si (KR); Jung Woon LEE, Suwon-si (KR)

(73) Assignee: Samsung Electronics Co., Ltd., Suwon-si (KR)

(21) Appl. No.: 19/266,473

(22) Filed: Jul. 11, 2025

(30) Foreign Application Priority Data
Sep. 27, 2024 (KR) 10-2024-0131544

(51) Int. Cl. H04L 25/02

(52) U.S. Cl. CPC H04L 25/0224

(57) ABSTRACT

Provided are a wireless communication apparatus and an operating method thereof, in which the wireless communication apparatus includes processing circuitry configured to calculate initial channel estimation values based on a reference pilot signal and a pilot signal, the pilot signal being received from a second wireless communication apparatus over a communication channel, the initial channel estimation values corresponding to the communication channel, calculate noise-whitened channel estimation values by applying a noise whitening filter to the initial channel estimation values, calculate channel-smoothed channel estimation values by applying a channel smoothing filter to the noise-whitened channel estimation values, and calculate final channel estimation values by inversely applying the channel smoothing filter and the noise whitening filter to the channel-smoothed channel estimation values.

### CROSS-REFERENCE TO RELATED APPLICATION

This application claims priority to Korean Patent Application No. 10-2024-0131544, filed in the Korean Intellectual Property Office on Sep. 27, 2024, the entire contents of which are hereby incorporated by reference.

### BACKGROUND

### Technical Field

The present disclosure relates to a wireless communication apparatus and an operating method thereof.

### Description of Related Art

Wireless communication, for example, the Wireless Local Area Network (WLAN) is a technology that connects two or more devices to each other using a wireless signal transmission method, and the WLAN technology may be based on the Institute of Electrical and Electronics Engineers (IEEE) 802.11 standard. The 802.11 standard has developed into 802.11b, 802.11a, 802.11g, 802.11n, 802.11ac, 802.11ax, and 802.11az, and may support high transmission rates with the adoption of the Orthogonal Frequency-Division Multiplexing (OFDM) technology.

The information described above is intended to improve understanding of the background of the present disclosure, and may include information that does not constitute the related art.

### SUMMARY

In order to solve one or more challenges (e.g., challenges described herein and/or other challenges not explicitly described herein), the present disclosure provides a wireless communication apparatus for achieving higher channel estimation performance under limited resources and an operating method thereof.

An object to be achieved by the present disclosure is not limited to the above, and other objects not mentioned may be clearly understood by those skilled in the art from the description of the present disclosure.

According to embodiments of the present disclosure, a first wireless communication apparatus may include processing circuitry configured to calculate initial channel estimation values based on a reference pilot signal and a pilot signal, the pilot signal being received from a second wireless communication apparatus over a communication channel, the initial channel estimation values corresponding to the communication channel, calculate noise-whitened channel estimation values by applying a noise whitening filter to the initial channel estimation values, calculate channel-smoothed channel estimation values by applying a channel smoothing filter to the noise-whitened channel estimation values, and calculate final channel estimation values by inversely applying the channel smoothing filter and the noise whitening filter to the channel-smoothed channel estimation values.

According to embodiments of the present disclosure, a first wireless communication apparatus may include processing circuitry configured to calculate noise-whitened channel estimation values by performing phase correction on a pilot signal based on a reference pilot signal, the pilot signal being received from a second wireless communication apparatus over a communication channel, the noise-whitened channel estimation values corresponding to the communication channel, calculate channel-smoothed channel estimation values by applying a channel smoothing filter to the noise-whitened channel estimation values, and calculate final channel estimation values by inversely applying the channel smoothing filter and a noise whitening filter to the channel-smoothed channel estimation values.

According to embodiments of the present disclosure, an operating method of a wireless communication apparatus may include calculating initial channel estimation values based on a reference pilot signal and a pilot signal, the pilot signal being received over a communication channel, calculating noise-whitened channel estimation values by applying a noise whitening filter to the initial channel estimation values, calculating channel-smoothed channel estimation values by applying a channel smoothing filter to the noise-whitened channel estimation values, and calculating final channel estimation values by inversely applying the channel smoothing filter and the noise whitening filter to the channel-smoothed channel estimation values.

According to embodiments of the present disclosure, even for the signal modulated by a modulation method in which at least some of the symbols have different powers, channel smoothing may be performed with lower processing complexity. Accordingly, higher channel estimation performance may be achieved under limited resources, and as a result, efficiency of the wireless communication apparatus or the system including the same may be increased.

The effects that may be obtained through the present disclosure are not limited to those described above. Technical effects not mentioned herein will be clearly understood by those skilled in the art from the description of the present disclosure described below.

### BRIEF DESCRIPTION OF THE DRAWINGS

The above and other objects, features and advantages of the present disclosure will become more apparent to those of ordinary skill in the art by describing in detail embodiments thereof with reference to the accompanying drawings, in which:

FIG. 1 is a diagram provided to explain a wireless communication system according to embodiments;

FIG. 2 is a block diagram illustrating a wireless communication system according to embodiments;

FIGS. 3 and 4 are diagrams provided to explain an example of a modulation method according to embodiments;

FIG. 5 is a diagram provided to explain an example of a communication method between a first wireless communication apparatus 100 and a second wireless communication apparatus according to embodiments;

FIG. 6 is a block diagram provided to explain an example of a channel estimation method according to embodiments;

FIG. 7 is a flow diagram provided to explain an example of a channel estimation method according to embodiments;

FIG. 8 is a flow diagram provided to explain a method for calculating initial channel estimation values according to embodiments;

FIG. 9 is a flow diagram provided to explain a method for calculating noise-whitened channel estimation values according to embodiments;

FIG. 10 is a flow diagram provided to explain a method for calculating channel-smoothed channel estimation values according to embodiments;

FIG. 11 is a flow diagram provided to explain a method for calculating final channel estimation values according to embodiments;

FIG. 12 is a flow diagram provided to explain a channel estimation method according to embodiments; and

FIG. 13 is a conceptual diagram illustrating an IoT network system according to embodiments.

### DETAILED DESCRIPTION

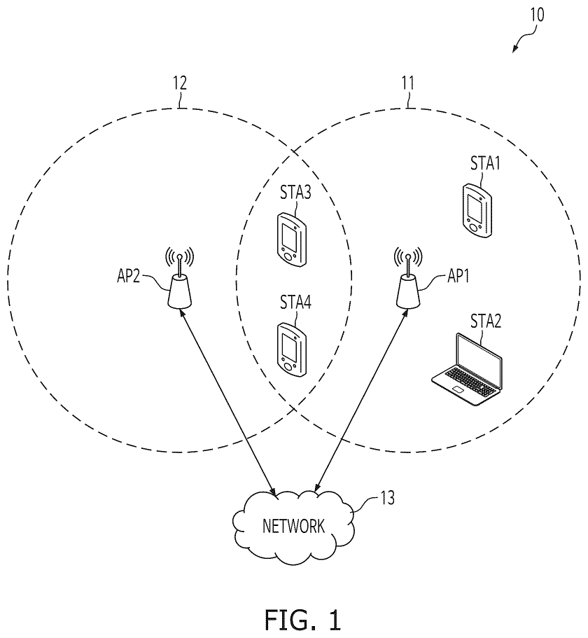

Hereinbelow, various aspects of the present disclosure will be described with reference to FIGS. 1 to 13. Throughout the description, the same (or similar) reference numerals may refer to the same (or similar) components.

FIG. 1 is a diagram provided to explain a wireless communication system 10 according to embodiments. Specifically, FIG. 1 illustrates a wireless local area network (WLAN) system as an example of the wireless communication system 10. While certain aspects of the present disclosure are described in detail below mainly with respect to wireless communication systems (e.g., wireless communication systems based on the IEEE 802.11 standard) based on Orthogonal Frequency Division Multiplexing (OFDM) or Orthogonal Frequency Division Multiple Access (OFDMA), the subject matter of the present disclosure is also applicable to other communication systems with similar technical backgrounds and/or channel forms (e.g., cellular communication systems such as long term evolution (LTE), LTE-advanced (LTE-A), new radio (NR), wireless broadband (WiBro), global system for mobile communication (GSM) and/or Bluetooth, near field communication systems such as near field communication (NFC)), etc., without departing from the scope of the present disclosure.

Furthermore, various functions described below may be implemented or supported by one or more computer programs, each of which may be configured with computer-readable program code and may be implemented on a non-transitory computer-readable medium. The terms “application” and “program” may refer to one or more computer programs, software components, instruction sets, procedures, functions, objects, classes, instances, related data, or parts of these that are suitable for the implementation of suitable computer-readable program code. The “computer-readable program code” may include any type of computer code including source code, object code, and/or execution code. “Computer-readable media” may include any type of media that may be accessed by a computer, such as read only memory (ROM), random access memory (RAM), hard disk drive, compact disk (CD), digital video disk (DVD), or any other type of memory. A “non-transitory” computer-readable medium may exclude wired, wireless, optical, or other communication links that transmit temporary electric or other signals. The non-transitory computer-readable medium may include a medium in which data may be permanently stored, and a medium in which data may be stored and overwritten later, such as a rewritable optical disk or an erasable memory device.

Referring to FIG. 1, the wireless communication system 10 may include first and second access points AP1 and AP2, and/or first to fourth stations STA1, STA2, STA3, and STA4. The first and second access points AP1 and AP2 may connect to a network 13 including the Internet, an Internet Protocol (IP) network, or any other networks. The first access point AP1 may provide access to the network 13 to the first to fourth stations STA1, STA2, STA3, and STA4 within a first coverage area 11. In addition, the second access point AP2 may provide access to the network 13 to the third and fourth stations STA3 and STA4 within a second coverage area 12. In embodiments, the first and second access points AP1 and AP2 may communicate with at least one of the first to fourth stations STA1, STA2, STA3, and STA4 based on wireless fidelity (WiFi) or any other WLAN connection technologies.

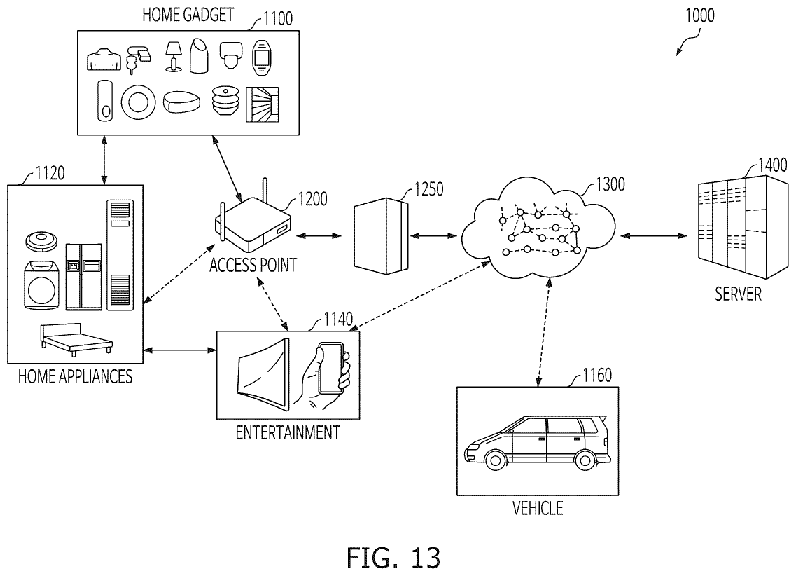

The access point may be referred to as a router, a gateway, etc., and the station may be referred to as a mobile station, a subscriber station, a terminal, a mobile terminal, a wireless terminal, user equipment, a user, etc. The station may be a portable device such as a mobile phone, a laptop computer, or a wearable device, or may be a stationary device such as a desktop computer, a smart TV, etc. Other examples of the access points and stations will be described below with reference to FIG. 13.

The first station STA1 may perform data communication with the first access point AP1. In this description, the first station STA1 may be referred to as a first wireless communication apparatus, and the first access point AP1 may be referred to as a second wireless communication apparatus.

The first access point AP1 may modulate a pilot sequence into symbols and transmit the same to the first station STA1 through a communication channel. In this case, the first station STA1 may receive a data signal including a pilot signal from the first access point AP1 through the communication channel. The wireless communication system 10 may be an OFDM-based system. In this case, the first station STA1 may receive the data signal including the pilot signal through a plurality of subcarriers orthogonal to each other. The pilot signal may include a long training field (LTF) signal. For example, the pilot signal may include an LTF signal (e.g., a high efficiency LTC (HE-LTF) signal) generated based on an encrypted pilot sequence. The first station STA1 may perform channel estimation based on the received pilot signal. For example, the first station STA1 may determine channel estimation values for the communication channel based on the received pilot signal.

However, channel estimation according to embodiments of the present disclosure may be performed by another wireless communication apparatus (STA2 to STA4, AP1, AP2) in the wireless communication system 10 in addition (or alternatively) to the first station STA1.

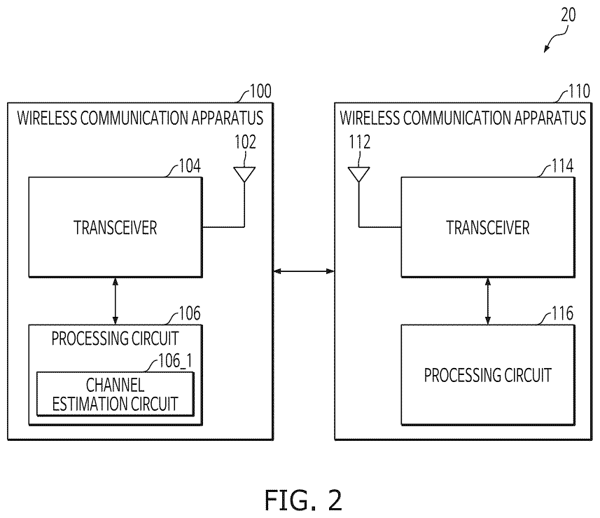

FIG. 2 is a block diagram illustrating a wireless communication system 20 according to embodiments. Specifically, the block diagram of FIG. 2 shows a first wireless communication apparatus 100 (e.g., the STA1) and a second wireless communication apparatus 110 (e.g., the AP1) communicating with each other in a wireless communication system 20. Each of the first wireless communication apparatus 100 and the second wireless communication apparatus 110 of FIG. 2 may be any apparatus communicating in the wireless communication system 20 (e.g., the STA1, the STA1, the STA3, the STA4, the AP1 and/or the AP2), and may be referred to as an apparatus for wireless communication. In embodiments, each of the first wireless communication apparatus 100 and the second wireless communication apparatus 110 may be a station or an access point of a WLAN system.

Referring to FIG. 2, the first wireless communication apparatus 100 may include an antenna 102, a transceiver 104, and/or a processing circuit 106. In embodiments, the antenna 102, the transceiver 104, and/or the processing circuit 106 may be included in one package or may be included in different packages, respectively. The second wireless communication apparatus 110 may also include an antenna 112, a transceiver 114, and/or a processing circuit 116. Hereinafter, redundant descriptions of the first wireless communication apparatus 100 and the second wireless communication apparatus 110 will be omitted. In addition, examples will be described below in which the first wireless communication apparatus 100 receives a data signal from the second wireless communication apparatus 110, in which the first wireless communication apparatus 100 may correspond to a receiving apparatus, and the second wireless communication apparatus 110 may correspond to a transmitting apparatus.

The antenna 102 may receive a data signal including the pilot signal from the second wireless communication apparatus 110 and provide the same to the transceiver 104. In embodiments, the antenna 102 may include a phased array for beamforming. The transceiver 104 may process the data signal received through the antenna 102 and provide the same to the processing circuit 106. In embodiments, the transceiver 104 may include analog circuits such as a low noise amplifier, a mixer, a filter, a power amplifier, etc.

The processing circuit 106 may include a channel estimation circuit 106_1. The channel estimation circuit 106_1 may receive the pilot signal from the transceiver 104. The channel estimation circuit 106_1 may determine channel estimation values for the communication channel through which the pilot signal is received.

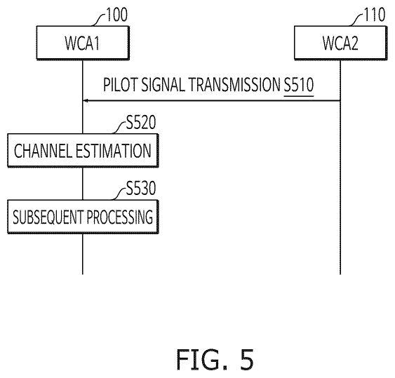

In this description, an example in which the processing circuit 106 includes the channel estimation circuit 106_1 is illustrated, but this is to clarify the subjects of operations according to embodiments, embodiments of the present disclosure are not limited thereto, and the operation of the channel estimation circuit 106_1 may be understood as the operation of the processing circuit 106. Details of a method of the first wireless communication apparatus 100 for performing channel estimation will be described below with reference to FIGS. 5 to 13.

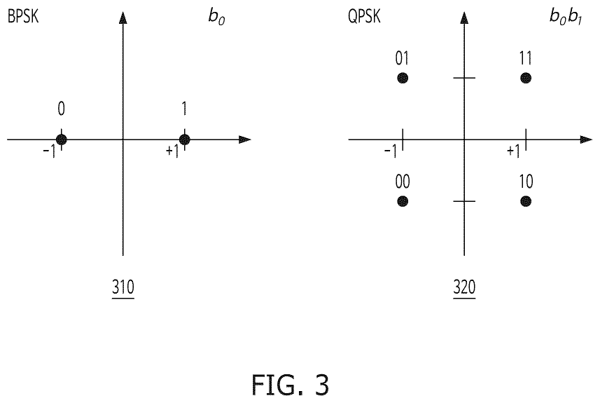

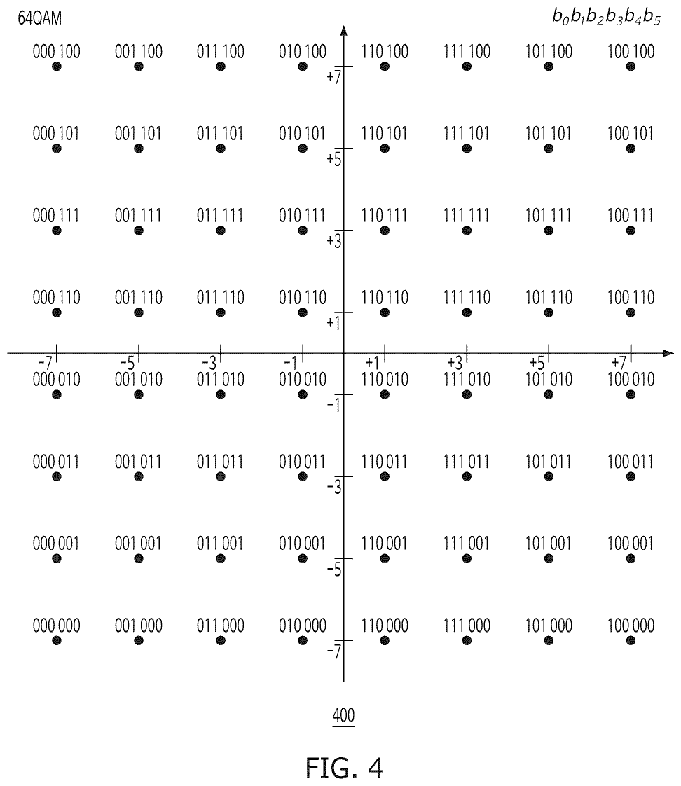

FIGS. 3 and 4 are diagrams provided to explain an example of a modulation method according to embodiments. In the communication system, information may generally be represented in the form of bits. The bits representing the information may be modulated into symbols to be transmitted through a communication channel. The symbol may refer to a signal unit into which digital signals may be modulated according to a transmission parameter (e.g., phase, amplitude, frequency, etc.) and transmitted. According to the modulation method, one or more bits may be modulated into symbols and transmitted through the communication channel.

A first example 310 and a second example 320 illustrated in FIG. 3 represent examples of a binary phase shift keying (BPSK) method and a quadrature phase shift keying (QPSK) method, respectively. Referring to the first example 310, in the BPSK method, bits may be mapped to two symbols having the same amplitude (or similar amplitudes) and different phases. Specifically, in the BPSK method, the two symbols may correspond to “0, 1”, respectively. Therefore, in the BPSK method, one bit may be mapped to one symbol. Referring to the second example 320, bits may be mapped to four symbols having the same amplitude (or similar amplitudes) and different phases in the QPSK method. Specifically, in the QPSK method, the four symbols may correspond to “00”, “01”, “10”, and “11”, respectively. Therefore, in the QPSK method, two bits may be mapped to one symbol. Referring to FIG. 3, it may be seen that the amplitudes, e.g., power, of all symbols are the same (or similar) in the modulation methods of the first example 310 and the second example 320.

A third example 400 illustrated in FIG. 4 shows an example of a 64-Quadrature Amplitude Modulation (64-QAM) method. Referring to the third example 400, in the 64-QAM method, bits may be mapped to 64 different symbols. Specifically, in the 64-QAM method, the 64 symbols may correspond to “000000”, “000001”, “000010”, . . . , “111110” and “111111”, respectively. Accordingly, in the 64-QAM method, six bits may be mapped to one symbol. Referring to FIG. 4, it may be seen that some symbols have different amplitudes, e.g., different powers, in the modulation method of the third example 400. According to the modulation method of the third example 400, the closer the symbol is to the origin, the smaller the power (e.g., the power amplitude) may be, and the farther the symbol is from the origin, the greater the power may be. In general, the higher modulation method may have different powers of at least some symbols as in the third example 400. For example, the power of at least some symbols may be different in the modulation methods such as 16-QAM or higher order QAM, 16-Amplitude and Phase Shift Keying (16-APSK) or higher order APSK, 4-Pulse Amplitude Modulation (4-PAM) or higher order PAM, etc. The higher modulation methods may map a larger number of bits to one symbol and thus have the advantage of higher data transmission rates. However, complexity for signal processing such as channel estimation may increase in most of higher modulation methods, because the powers of at least some symbols are different.

FIG. 5 is a diagram provided to explain an example of a communication method between the first wireless communication apparatus (also referred to as the “WCA1”) 100 and the second wireless communication apparatus (also referred to as the “WCA2”) 110 according to embodiments. Referring to FIG. 5, the first wireless communication apparatus 100 (e.g., the transceiver of the first wireless communication apparatus 100, etc.) may receive a pilot signal from the second wireless communication apparatus 110 through a communication channel, at S510. The pilot signal may be received through a plurality of subcarriers orthogonal to each other. In this case, the pilot signal may include a plurality of sub-signals received through each of the plurality of subcarriers.

The pilot signal received from the second wireless communication apparatus 110 may be a signal with the power of at least some symbols modulated by different modulation methods (or modulated by one among several different modulation methods). For example, the pilot signal may be a signal modulated by a modulation method such as 16-QAM or higher order QAM (e.g., 64-QAM, etc.), 16-APSK or higher order APSK, 4-PAM or higher order PAM, etc. Accordingly, the received pilot signal may have different powers in at least some of the plurality of subcarriers. That is, at least some of the plurality of sub-signals included in the received pilot signal may have different powers from each other.

The first wireless communication apparatus 100 (e.g., a processing circuit of the first wireless communication apparatus 100) may perform channel estimation based on the received pilot signal, at S520. Specifically, the first wireless communication apparatus 100 may determine channel estimation values for the communication channel through which the pilot signal is received. The method of the first wireless communication apparatus 100 for performing channel estimation will be described in detail below with reference to FIGS. 5 to 12.

The first wireless communication apparatus 100 may perform various subsequent processes using the determined channel estimation values, at S530. For example, the determined channel estimation values may be used to estimate the position of the first wireless communication apparatus 100. For example, the first wireless communication apparatus 100 may analyze a Line Of Site (LOS) path based on the channel estimation values and estimate a distance between the first wireless communication apparatus 100 and the second wireless communication apparatus 110 based on the analysis result. The estimated distance may be used for estimating the position of the first wireless communication apparatus 100. As another example, the first wireless communication apparatus 100 may demodulate data received from the second wireless communication apparatus 110 based on the determined channel estimation values. In addition, the first wireless communication apparatus 100 may perform various subsequent processes (e.g., beamforming, etc.) based on the channel estimation result. According to embodiments, the first wireless communication apparatus 100 may generate a first signal, process the first signal to perform one or more among modulating, upconverting, filtering, amplifying and/or encrypting on the first signal, and transmit the processed first signal (e.g., a beamformed signal based on the channel estimation result) to another device (e.g., the second wireless communication apparatus 110). Additionally or alternatively, the first wireless communication apparatus 100 may receive a second signal (e.g., a beamformed signal based on the channel estimation result) from the second wireless communication apparatus 110, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application (e.g., an application performing a function based on the estimated position) executing on the first wireless communication apparatus 100, storing the processed second signal, sending a response signal to the second wireless communication apparatus 110 (e.g., based on a processing result of the corresponding application executing on the first wireless communication apparatus), etc.

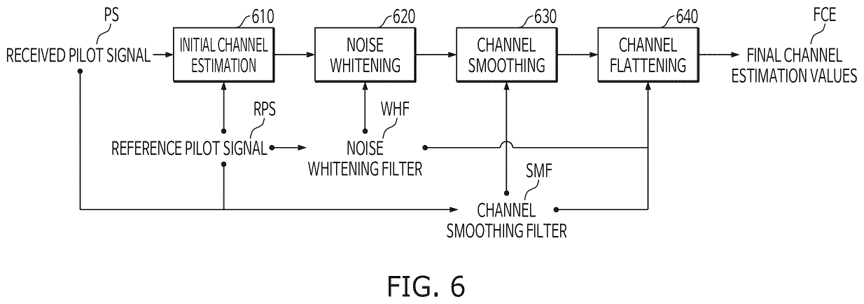

FIG. 6 is a block diagram illustrating an example of a channel estimation method according to embodiments. The channel estimation method may be performed by a processing circuit (e.g., the processing circuit of the wireless communication apparatus).

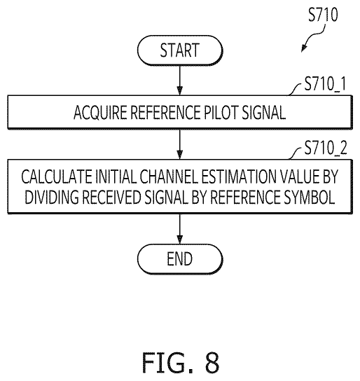

First, the processing circuit may calculate initial channel estimation values by performing an initial channel estimation 610 based on the received pilot signal PS and a reference pilot signal RPS. The received pilot signal PS may have different powers from each other in at least some of a plurality of subcarriers. Accordingly, at least some of the variances of noise included in the initial channel estimation values may be different from each other. Details of the initial channel estimation method will be described below with reference to FIG. 8.

The processing circuit may perform channel smoothing 630 to improve the channel estimation performance. If all the variances of noise included in the initial channel estimation values are not the same (or similar), processing complexity for the channel smoothing 630 may be higher. To address this issue, the processing circuit may perform the channel smoothing 630 after performing noise whitening 620. In addition, after performing the channel smoothing 630, the processing circuit may calculate final channel estimation (FCE) values by performing channel flattening 640.

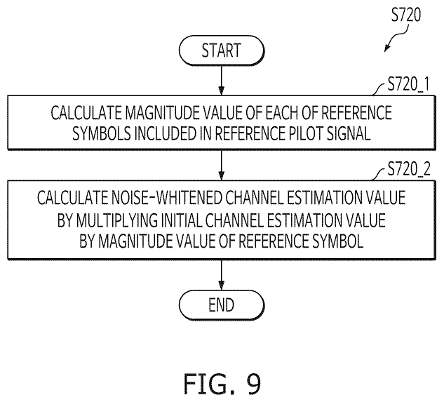

For example, the processing circuit may perform the noise whitening 620 on the initial channel estimation values. Specifically, the processing circuit may calculate noise-whitened channel estimation values by applying a noise whitening filter (WHF) to the initial channel estimation values. The noise whitening filter (WHF) may be determined and/or generated based on the reference pilot signal RPS. Performing the noise whitening 620 may make the variances of noise included in the noise-whitened channel estimation values all uniform (or similar). Details of the noise whitening method will be described below with reference to FIG. 9.

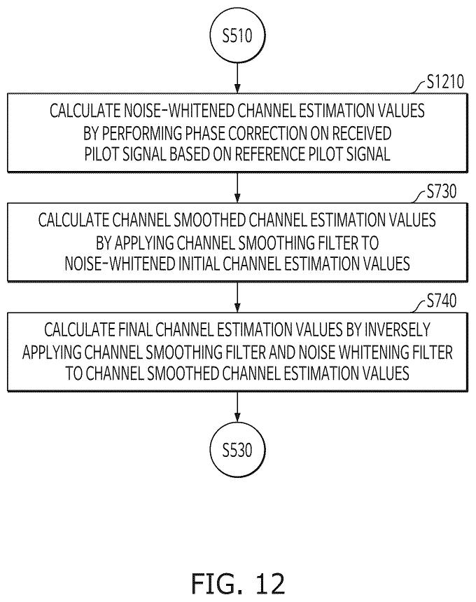

The initial channel estimation 610 and the noise whitening 620 may be performed at the same time (or contemporaneously). For example, the processing circuit may concurrently perform the initial channel estimation 610 and the noise whitening 620 by performing phase correction on the received pilot signal PS. This will be described in detail below with reference to FIG. 12.

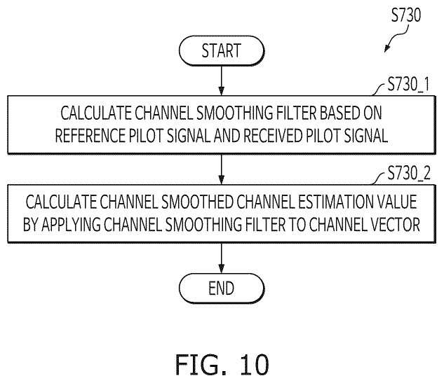

The processing circuit may perform the channel smoothing 630 on the noise-whitened channel estimation values. Specifically, the processing circuit may calculate channel-smoothed channel estimation values by applying a channel smoothing filter (SMF) to the noise-whitened channel estimation values. The channel smoothing filter (SMF) may be determined based on the received pilot signal PS and the reference pilot signal RPS. Since the variances of noise included in the noise-whitened channel estimation values are all uniform (or similar), the same channel smoothing filter (SMF) (or similar SMFs) may be applied to each of the plurality of subcarriers when the channel smoothing 630 is performed. Details of the channel smoothing method will be described below with reference to FIG. 10.

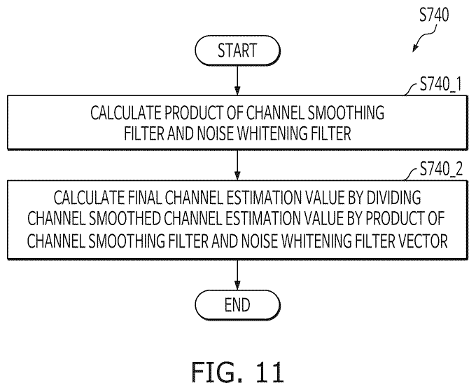

The processing circuit may perform the channel flattening 640 on the channel-smoothed channel estimation values. Specifically, the processing circuit may calculate the final channel estimation (FCE) values by inversely applying the noise whitening filter (WHF) and the channel smoothing filter (SMF) to the channel-smoothed channel estimation values. Details of the channel flattening method will be described below with reference to FIG. 11.

As described above, even for the signal modulated by the modulation method in which at least some of the symbols have different powers, the channel smoothing 630 may be performed with lower processing complexity. Accordingly, higher channel estimation performance may be achieved with less resources, and as a result, efficiency of the wireless communication apparatus or the system including the same may be increased.

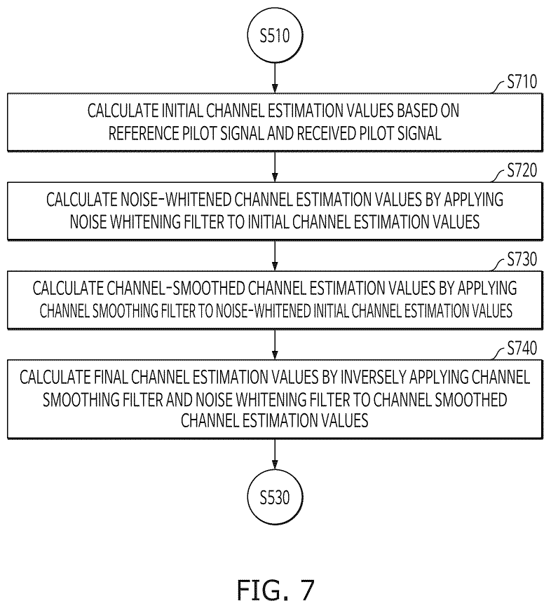

FIG. 7 is a flow diagram provided to explain an example of the channel estimation method according to embodiments. The channel estimation method may be performed by a processing circuit (e.g., the processing circuit of the first wireless communication apparatus). The channel estimation method may be performed after the operation of receiving the pilot signal from the second wireless communication apparatus (e.g., S510 of FIG. 5).

First, the processing circuit may calculate the initial channel estimation values based on the reference pilot signal and the received pilot signal, at S710. The processing circuit may calculate the initial channel estimation values using the least squares estimation. Details of the method for calculating the initial channel estimation values will be described below with reference to FIG. 8.

In addition, the processing circuit may calculate the noise-whitened channel estimation values by applying the noise whitening filter to the initial channel estimation values, at S720. The noise whitening filter may be determined/generated based on the reference pilot signal. Details of the method for calculating the noise-whitened channel estimation values will be described below with reference to FIG. 9.

The processing circuit may apply the channel smoothing filter to the noise-whitened channel estimation values to calculate the channel-smoothed channel estimation values, at S730. The processing circuit may apply the same channel smoothing filter (or similar channel smoothing filters) to each of the plurality of subcarriers. Details of the channel smoothing method will be described below with reference to FIG. 10.

The processing circuit may calculate the final channel estimation values by inversely applying the channel smoothing filter and the noise whitening filter to the channel-smoothed channel estimation values, at S740. Details of the method for calculating the final channel estimation values will be described below with reference to FIG. 11.

The processing circuit may perform various subsequent processes (e.g., distance estimation, data demodulation, etc.) based on the calculated final channel estimation values, at S530 of FIG. 5.

FIG. 8 is a flow diagram provided to explain a method (S710) for calculating the initial channel estimation values according to embodiments.

Referring to FIG. 8, the processing circuit may acquire the received pilot signal and the reference pilot signal, at S710_1. For example, the processing circuit may receive the pilot signal from the transceiver and load the reference pilot signal stored in the memory or storage device (e.g., the reference pilot signal may be stored prior to receiving the pilot signal) accessible by the processing circuit (e.g., included in the first wireless communication apparatus 100), but embodiments are not limited thereto.

The received pilot signal may be a signal received through a plurality of subcarriers orthogonal to each other. In this case, the pilot signal may include a plurality of sub-signals received via the plurality of subcarriers. For example, one sub-signal may be received through one subcarrier. Further, the reference pilot signal may include a plurality of reference symbols corresponding to the plurality of sub-signals. For example, one reference symbol may correspond to one sub-signal. The received pilot signal may have different powers (e.g., different power magnitudes or amplitudes) in at least some of the plurality of subcarriers. That is, at least some of the plurality of sub-signals may have different powers. Accordingly, at least some of the plurality of reference symbols may also have different powers.

According to the Adaptive White Gaussian Noise (AWGN) channel model, the relationship between a specific sub-signal included in the received pilot signal and a specific reference symbol associated with the specific sub-signal may be expressed by Equation 1 below.

$${y}_{k} = {s}_{k} + {n}_{k} \qquad < Equation 1 >$$

where, yₖ, sₖ, nₖ may represent a sub-signal, a reference symbol, and a noise associated with a k-th subcarrier, respectively.

According to the linear fading channel model, the relationship between a specific sub-signal included in the received pilot signal and a specific reference symbol associated with the specific sub-signal may be expressed by Equation 2 below.

$${y}_{k} = {H}_{k} * {s}_{k} + {n}_{k} \qquad < Equation 2 >$$

where, yₖ, Hₖ, sₖ, nₖ may represent a sub-signal, a channel response, a reference symbol, and a noise associated with a k-th subcarrier, respectively.

The processing circuit may calculate the initial channel estimation values by using the least square estimation based on the reference pilot signal and the received pilot signal. For example, for each of the plurality of subcarriers, the processing circuit may divide the sub-signal by the reference symbol to calculate an initial channel estimation value for each of the plurality of subcarriers, at S710_2. As a specific example, the initial channel estimation value for each of the plurality of subcarriers may be calculated by Equation 3 below.

$${{y}_{k} ( {s}_{k} )}^{- 1} {=}^{Δ} {r}_{k} \qquad < Equation 3 >$$

where, yₖ, sₖ, rₖ may represent a sub-signal, a reference symbol, and an initial channel estimation value associated with a k-th subcarrier, respectively.

In this case, according to the AWGN channel model, the initial channel estimation value may be expressed by Equation 4 below, and according to the linear fading channel model, the initial channel estimation value may be expressed by Equation 5 below.

$${r}_{k} = 1 + {{n}_{k} ( {s}_{k} )}^{- 1} \qquad < Equation 4 >$$

$${r}_{k} = {H}_{k} + {{n}_{k} ( {s}_{k} )}^{- 1} \qquad < Equation 5 >$$

In Equations 4 and 5, rₖ, Hₖ, sₖ, nₖ may represent an initial channel estimation value, a channel response, a reference symbol, and a noise associated with a k-th subcarrier, respectively.

If at least some of the plurality of sub-signals have different powers, at least some of the plurality of reference symbols may also have different powers. In this case, referring to Equations 4 and 5, at least some of the variances of noise included in the initial channel estimation values may be different from each other.

FIG. 9 is a flow diagram provided to explain a method (S720) for calculating noise-whitened channel estimation values according to embodiments.

Referring to FIG. 9, the processing circuit may calculate noise whitening filter values included in the noise whitening filter. The noise whitening filter may include magnitude values of each of the reference symbols included in the reference pilot signal. In this case, the processing circuit may calculate the magnitude values of each of the reference symbols included in the reference pilot signal, at S720_1.

The processing circuit may multiply the initial channel estimation value for each of the plurality of subcarriers by the magnitude value of the reference symbol to calculate a noise-whitened channel estimation value for each of the plurality of subcarriers, at S720_2. For example, the noise-whitened channel estimation value for each of the plurality of subcarriers may be calculated by Equation 6 below.

$${r}_{k} * {q}_{k} {=}^{Δ} {α}_{k} , where {q}_{k} = \vert {s}_{k} \vert \qquad < Equation 6 >$$

where, rₖ, qₖ, αₖ, sₖ may represent an initial channel estimation value, a noise whitening filter value, a noise-whitened channel estimation value, and a reference symbol associated with a k-th subcarrier, respectively.

After noise whitening, the variances of noise included in the noise-whitened channel estimation values for the plurality of subcarriers may all be uniform (or similar).

FIG. 10 is a flow diagram for explaining a method (S730) for calculating the channel-smoothed channel estimation values according to embodiments.

The processing circuit may perform channel smoothing. The channel smoothing filter may be a minimum mean square error (MMSE) channel smoothing filter. For example, the channel smoothing filter may be a Wiener filter. As a specific example, a channel smoothing filter having a length of 5 may be expressed by Equation 7 below. Although the example in which the length of the filter is 5 illustrated, the length of the filter is not limited thereto.

$${w}_{k} = {[ \begin{matrix}{R}_{0} + {σ}_{k - 2}^{2} & {R}_{1} & {R}_{2} & {R}_{3} & {R}_{4} \\ {R}_{1} & {R}_{0} + {σ}_{k - 1}^{2} & {R}_{1} & {R}_{2} & {R}_{3} \\ {R}_{2} & {R}_{1} & {R}_{0} + {σ}_{k}^{2} & {R}_{1} & {R}_{2} \\ {R}_{3} & {R}_{2} & {R}_{1} & {R}_{0} + {σ}_{k + 1}^{2} & {R}_{1} \\ {R}_{4} & {R}_{3} & {R}_{2} & {R}_{1} & {R}_{0} + {σ}_{k + 2}^{2}\end{matrix} ]}^{- 1} [ \begin{matrix}{R}_{2} \\ {R}_{1} \\ {R}_{0} \\ {R}_{1} \\ {R}_{2}\end{matrix} ] , \qquad < Equation 7 >$$

where, wₖ may be a channel smoothing filter applied to a k-th subcarrier,

$${σ}_{k}^{2}$$

may be a variance of noise included in the channel estimation value for the k-th subcarrier, and

$${R}_{n} = {\sum }_{l = 0}^{L - 1} {\vert {h}_{l} \vert}^{2} exp ( - \frac{j 2 π n l}{{N}_{f f t}} )$$

for n=1, 2, . . . , L and may be a channel impulse response in a multi-path environment in which the number of paths is L. Referring to Equation 7, if the variance of noise included in the channel estimation values for the plurality of subcarriers are not uniform, the channel smoothing filter varies for each subcarrier, which may increase the complexity of the channel smoothing process. By performing noise whitening before channel smoothing, the variances of noise included in the noise-whitened channel estimation values for the plurality of subcarriers become all uniform (or similar), thus reducing the complexity of channel smoothing.

Referring to FIG. 10, first, the processing circuit may calculate a channel smoothing filter based on the reference pilot signal and the received pilot signal, at S730_1. For example, when the length of the filter is 5, the channel smoothing filter may be calculated by Equation 8 below.

$$w = {[ \begin{matrix}{R}_{0} + {σ}^{2} & {R}_{1} & {R}_{2} & {R}_{3} & {R}_{4} \\ {R}_{1} & {R}_{0} + {σ}^{2} & {R}_{1} & {R}_{2} & {R}_{3} \\ {R}_{2} & {R}_{1} & {R}_{0} + {σ}^{2} & {R}_{1} & {R}_{2} \\ {R}_{3} & {R}_{2} & {R}_{1} & {R}_{0} + {σ}^{2} & {R}_{1} \\ {R}_{4} & {R}_{3} & {R}_{2} & {R}_{1} & {R}_{0} + {σ}^{2}\end{matrix} ]}^{- 1} [ \begin{matrix}{R}_{2} \\ {R}_{1} \\ {R}_{0} \\ {R}_{1} \\ {R}_{2}\end{matrix} ] {=}^{Δ} {[ {w}_{- 2} , {w}_{- 1} , {w}_{0} , {w}_{1} , {w}_{2} ]}^{T} \qquad < Equation 8 >$$

where, w may be a channel smoothing filter, σ² may be a variance of noise included in the noise-whitened channel estimation value, and

$${R}_{n} = {\sum }_{l = 0}^{L - 1} {\vert {h}_{l} \vert}^{2} exp ( - \frac{j 2 π n l}{{N}_{f f t}} )$$

for n=1, 2, . . . , L and may be a channel impulse response in a multi-path environment in which the number of paths is L. Since the variances of noise included in the noise-whitened channel estimation values are uniform (or similar) across the plurality of subcarriers, the same channel smoothing filter (or similar channel smoothing filters) may be applied to the plurality of subcarriers.

By applying the channel smoothing filter to the channel vector for each of the plurality of subcarriers (e.g., to a plurality of channel vectors for the plurality of subcarriers, each respective channel vector among the plurality of channel vectors corresponding to a different subcarrier among the plurality of subcarriers), a channel-smoothed channel estimation value for each of the plurality of subcarriers may be calculated, at S730_2. The channel vector for each of the plurality of subcarriers may include a noise-whitened channel estimation value for a specific subcarrier and a predetermined (or alternatively, given) number of noise-whitened channel estimation values associated with subcarriers adjacent to the specific subcarrier. The length of the filter may be a value obtained by adding 1 to the predetermined (or alternatively, given) number. For example, if the predetermined (or alternatively, given) number is 4 and the length of the filter is 5, the channel vector may be expressed by Equation 9 as follows.

$$[ \begin{matrix}{α}_{k - 2} \\ {α}_{k - 1} \\ {α}_{k} \\ {α}_{k + 1} \\ {α}_{k + - 2}\end{matrix} ] {=}^{Δ} {α}_{k} \qquad < Equation 9 >$$

where, αₖ, αₖ may represent a noise-whitened channel estimation value and a channel vector for a k-th subcarrier, respectively.

In addition, the channel-smoothed channel estimation value for each of the plurality of subcarriers may be calculated by Equation 10 as follows.

$${w}^{{}_{H}} {α}_{k} {=}^{Δ} {β}_{k} \qquad < Equation 10 >$$

where, w may represent a channel smoothing vector, and αₖ, βₖ may represent a channel vector and a channel-smoothed channel estimation value for a k-th subcarrier, respectively.

FIG. 11 is a flow diagram provided to explain a method (S740) for calculating final channel estimation values according to embodiments.

The processing circuit may calculate the final channel estimation values by inversely applying the noise whitening filter and the channel smoothing filter to the channel-smoothed channel estimation values. For example, based on the channel-smoothed channel estimation value for each of the plurality of subcarriers, and the product of the channel smoothing filter and the noise whitening filter vector, the final channel estimation value for each of the plurality of subcarriers may be calculated.

Referring to FIG. 11, first, the processing circuit may calculate a product of the channel smoothing filter and the noise whitening filter vector associated with each of the plurality of subcarriers, at S740_1. The noise whitening filter vector may include a noise whitening filter value associated with a specific subcarrier and a predetermined (or alternatively, given) number of noise whitening filter values associated with subcarriers adjacent to the specific subcarrier. The predetermined (or alternatively, given) number may be the same as (or similar to) the predetermined (or alternatively, given) number described above in the channel smoothing operation (the predetermined (or alternatively, given) number described above with reference to FIG. 10). That is, the length of the noise whitening filter vector may be the same as (or similar to) the length of the channel smoothing filter. For example, if the predetermined (or alternatively, given) number is 4 and the length of the noise whitening filter vector is 5, the noise whitening filter vector may be expressed by Equation 11 below.

$${q}_{k} {=}^{Δ} {[ \vert {s}_{k - 2} \vert \vert {s}_{k - 1} \vert \vert {s}_{k} \vert \vert {s}_{k + 1} \vert \vert {s}_{k + 2} \vert ]}^{T} \qquad < Equation 11 >$$

where, qₖ may represent a noise whitening filter vector associated with a k-th subcarrier and |sₖ| may represent a noise whitening filter value associated with the k-th subcarrier (e.g., the magnitude value of the reference symbol associated with the k-th subcarrier).

For each of the plurality of subcarriers, the processing circuit may divide the channel-smoothed channel estimation value by the product of the channel smoothing filter and the noise whitening filter vector to calculate a final channel estimation value for each of the plurality of subcarriers, at S740_2. For example, the final channel estimation value for each of the plurality of subcarriers may be calculated by Equation 12 below.

$${β}_{k} / ( {w}^{{}_{H}} {q}_{k} ) {=}^{Δ} {\tilde{H}}_{k} , \qquad < Equation 12 >$$

where, w may represent a channel smoothing filter, and βₖ, qₖ, \tilde{H}ₖ may represent a channel-smoothed channel estimation value, a noise-whitened filter vector, and a final channel estimation value for a k-th subcarrier, respectively.

FIG. 12 is a flow diagram provided to explain a channel estimation method according to embodiments. The channel estimation method may be performed by a processing circuit (e.g., the processing circuit of the first wireless communication apparatus). The channel estimation method may be performed after the operation of receiving the pilot signal from the second wireless communication apparatus (e.g., S510 of FIG. 5).

The processing circuit may calculate noise-whitened channel estimation values by performing phase correction on the received pilot signal based on the reference pilot signal, at S1210. For example, for each of the plurality of subcarriers, the processing circuit may perform phase correction for the sub-signal based on the reference symbol to calculate the noise-whitened channel estimation value for each of the plurality of subcarriers. As a specific example, the noise-whitened channel estimation value for each of the plurality of subcarriers may be calculated by Equation 13 below.

$${y}_{k} * {exp}^{- j * ar g ( {s}_{k} )} {=}^{Δ} {α}_{k} \qquad < Equation 13 >$$

where, yₖ, sₖ, αₖ may represent a sub-signal, a reference symbol, and a noise-whitened channel estimation value associated with a k-th subcarrier, respectively.

The processing circuit may apply the channel smoothing filter to the noise-whitened channel estimation values to calculate the channel-smoothed channel estimation values, at S730. For example, channel smoothing may be performed as described above with reference to FIG. 10.

The processing circuit may calculate the final channel estimation values by inversely applying the channel smoothing filter and the noise whitening filter to the channel-smoothed channel estimation values, at S740. For example, the calculation of the final channel estimation values may be performed as described above with reference to FIG. 11.

The processing circuit may perform various subsequent processes (e.g., distance estimation, data demodulation, etc.) (e.g., S530 in FIG. 5) based on the calculated final channel estimation values.

The flow diagram of FIGS. 7 to 12 and the above description are only examples, and may be implemented differently in embodiments. For example, in embodiments, the order of operations may change, some operations may be performed concurrently, or some of the operations may be repeated, or added/omitted/changed. Additionally or alternatively, at least some of the operations may be performed by a different entity.

FIG. 13 is a conceptual diagram illustrating an IoT network system 1000 according to embodiments.

Referring to FIG. 13, the IoT network system 1000 may include a plurality of IoT devices 1100, 1120, 1140, and 1160, an access point 1200, a gateway 1250, a wireless network 1300, and/or a server 1400. Internet of Things (IoT) may refer to a network between objects that use wired and/or wireless communication.

Each of the IoT devices 1100, 1120, 1140, and 1160 may form a group according to the characteristics of each IoT device. For example, the IoT devices may be grouped into a home gadget group 1100, a home appliance/furniture group 1120, an entertainment group 1140, or a vehicle group 1160. The plurality of IoT devices 1100, 1120, and 1140 may be connected to a communication network or other IoT devices through the access point 1200. The access point 1200 may be embedded in a single IoT device. The gateway 1250 may change the protocol to connect the access point 1200 to an external wireless network. The IoT devices 1100, 1120, and 1140 may be connected to an external communication network through the gateway 1250. The wireless network 1300 may include the Internet and/or a public network. The plurality of IoT devices 1100, 1120, 1140, and 1160 may be connected to the server 1400 that provides a predetermined (or alternatively, given) service through the wireless network 1300, and user may use the service through at least one of the plurality of IoT devices 1100, 1120, 1140, and 1160.

According to embodiments, the plurality of IoT devices 1100, 1120, 1140, and 1160 may perform a channel estimation operation according to the aspects described in FIGS. 1 to 12. Accordingly, the IoT devices 1100, 1120, 1140, and 1160 may perform efficient and effective communication to provide higher-quality services to users.

Modulation methods involving the mapping of a larger number of bits to each single symbol enable higher data transmission rates. However, such modulation methods also utilize symbols mapped to different powers (e.g., signal magnitudes and/or amplitudes). These different symbol powers increase the complexity of a channel smoothing process performed during channel estimation. For example, the channel smoothing process may involve the use of a different channel smoothing filter for each subcarrier of a pilot signal due to the different noise variances included in channel estimation values resulting from the different symbol powers. Conventional devices and methods for performing channel estimation address this increased complexity by performing the channel smoothing process using additional resources (e.g., power, processor, memory, delay, etc.) to implement the different channel smoothing filters, resulting in excessive resource consumption (e.g., power, processor, memory, delay, etc.).

However, according to embodiments, improved devices and methods are provided for performing channel estimation. For example, the improved devices and methods may involve performing a noise whitening operation that normalizes the noise variances of the different subcarriers of a pilot signal resulting in a uniform (or similar) noise variance for all of the subcarriers. The improved devices and methods may also involve performing a channel smoothing process using only a single channel smoothing filter corresponding to the uniform (or similar) noise variance resulting from the noise whitening operation. Accordingly, the improved devices and methods are able to perform the channel smoothing process using less resources. Therefore, the improved devices and methods overcome the deficiencies of the conventional devices and methods to at least reduce resource consumption (e.g., power, processor, memory, delay, etc.). This reduction in resource consumption in particularly advantageous in mobile devices having limited resources (e.g., battery power).

According to embodiments, operations described herein as being performed by the wireless communication system 10, each among the first and second access points AP1 and AP2, each among the first to fourth stations STA1, STA2, STA3, and STA4, the first wireless communication apparatus 100, the second wireless communication apparatus 110, the wireless communication system 20, the transceiver 104, the processing circuit 106, the transceiver 114, the processing circuit 116, the channel estimation circuit 106_1, the IoT network system 1000, each among the plurality of IoT devices 1100, 1120, 1140, and 1160, the access point 1200, the gateway 1250, and/or the server 1400 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., a memory included in the first wireless communication apparatus 100). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

1. A first wireless communication apparatus, comprising:
processing circuitry configured to,
calculate initial channel estimation values based on a reference pilot signal and a pilot signal, the pilot signal being received from a second wireless communication apparatus over a communication channel, the initial channel estimation values corresponding to the communication channel,
calculate noise-whitened channel estimation values by applying a noise whitening filter to the initial channel estimation values,
calculate channel-smoothed channel estimation values by applying a channel smoothing filter to the noise-whitened channel estimation values, and
calculate final channel estimation values by inversely applying the channel smoothing filter and the noise whitening filter to the channel-smoothed channel estimation values.

2. The first wireless communication apparatus of claim 1, wherein the pilot signal is received through a plurality of subcarriers orthogonal to each other.

3. The first wireless communication apparatus of claim 2, wherein the pilot signal has different powers in at least some of the plurality of subcarriers.

4. The first wireless communication apparatus of claim 1, wherein the pilot signal includes at least one of:
a signal modulated using 16-Quadrature Amplitude Modulation (16-QAM) or higher order QAM; or
a signal modulated using 4-Pulse Amplitude Modulation (4-PAM) or higher order PAM.

5. The first wireless communication apparatus of claim 2, wherein the processing circuitry is configured to:
calculate an initial channel estimation value for each of the plurality of subcarriers to obtain a plurality of initial channel estimation values; and
calculate a noise-whitened channel estimation value for each of the plurality of subcarriers by applying the noise whitening filter to the plurality of initial channel estimation values.

6. The first wireless communication apparatus of claim 1, wherein the noise whitening filter includes a magnitude value of each of a plurality of reference symbols included in the reference pilot signal.

7. The first wireless communication apparatus of claim 2, wherein channel smoothing filter applied to the noise-whitened channel estimation values corresponding to each of the plurality of subcarriers is the same.

8. The first wireless communication apparatus of claim 2, wherein
the processing circuitry is configured to calculate a channel-smoothed channel estimation value for each of the plurality of subcarriers by applying a channel smoothing filter to a channel vector for each of the plurality of subcarriers;
the channel vector for each of the plurality of subcarriers includes a first noise-whitened channel estimation value for a first subcarrier and a number of second noise-whitened channel estimation values associated with second subcarriers adjacent to the first subcarrier, the first subcarrier and the second subcarriers being among the plurality of subcarriers; and
the channel smoothing filter applied to the channel vector for each of the plurality of subcarriers is the same.

9. The first wireless communication apparatus of claim 1, wherein the channel smoothing filter is a Minimum Mean Square Error (MMSE) channel smoothing filter.

10. The first wireless communication apparatus of claim 8, wherein
the processing circuitry is configured to calculate a final channel estimation value for each of the plurality of subcarriers based on,
the channel-smoothed channel estimation value for each of the plurality of subcarriers, and
a product of the channel smoothing filter and a noise whitening filter vector; and
the noise whitening filter vector includes a noise whitening filter value associated with the first subcarrier and a number of noise whitening filter values associated with third subcarriers adjacent to the first subcarrier, the number of noise whitening filter values being the same as the number of second noise-whitened channel estimation values, and the third subcarriers being among the plurality of subcarriers.

11. The first wireless communication apparatus of claim 1, wherein the processing circuitry is configured to calculate the initial channel estimation values by using a least square estimation based on the pilot signal and the reference pilot signal.

12. The first wireless communication apparatus of claim 2, wherein
the pilot signal includes a first sub-signal received through a first subcarrier among the plurality of subcarriers;
the reference pilot signal includes a first reference symbol associated with the first sub-signal; and
the processing circuitry is configured to calculate a first initial channel estimation value for the first subcarrier by dividing the first sub-signal by the first reference symbol.

13. The first wireless communication apparatus of claim 1, wherein the pilot signal includes long training field (LTF) signals.

14. The first wireless communication apparatus of claim 1, wherein the pilot signal includes an LTF signal generated based on an encrypted pilot sequence.

15. The first wireless communication apparatus of claim 1, wherein the processing circuitry is configured to estimate a distance between the first wireless communication apparatus and the second wireless communication apparatus based on the final channel estimation values.

16. The first wireless communication apparatus of claim 1, wherein the processing circuitry is configured to perform demodulation on data received from the second wireless communication apparatus based on the final channel estimation values.

17. A first wireless communication apparatus, comprising:
processing circuitry configured to,
calculate noise-whitened channel estimation values by performing phase correction on a pilot signal based on a reference pilot signal, the pilot signal being received from a second wireless communication apparatus over a communication channel, the noise-whitened channel estimation values corresponding to the communication channel,
calculate channel-smoothed channel estimation values by applying a channel smoothing filter to the noise-whitened channel estimation values, and
calculate final channel estimation values by inversely applying the channel smoothing filter and a noise whitening filter to the channel-smoothed channel estimation values.

18. The first wireless communication apparatus of claim 17, wherein
the pilot signal is received through a plurality of subcarriers orthogonal to each other.
the pilot signal has different powers in at least some of the plurality of subcarriers; and
the channel smoothing filter applied to the noise-whitened channel estimation values corresponding to each of the plurality of subcarriers is the same.

19. The first wireless communication apparatus of claim 18, wherein
the pilot signal includes a first sub-signal received through a first subcarrier among the plurality of subcarriers;
the reference pilot signal includes a first reference symbol associated with the first sub-signal; and
the processing circuitry is configured to calculate a first noise-whitened channel estimation value for the first subcarrier by performing phase correction on the first sub-signal based on the first reference symbol.

20. An operating method of a wireless communication apparatus, the method comprising:
calculating initial channel estimation values based on a reference pilot signal and a pilot signal, the pilot signal being received over a communication channel;
calculating noise-whitened channel estimation values by applying a noise whitening filter to the initial channel estimation values;
calculating channel-smoothed channel estimation values by applying a channel smoothing filter to the noise-whitened channel estimation values; and
calculating final channel estimation values by inversely applying the channel smoothing filter and the noise whitening filter to the channel-smoothed channel estimation values.
